(19) United States
(12) Patent Application Publication
(10) Pub. No.: US 2013/0088707 A1
(43) Pub. Date: Apr. 11, 2013

(54) METHOD AND SYSTEM FOR CRACK DETECTION

(71) Applicant: Behzad IMANI, San Mateo, CA (US)

(72) Inventor: Behzad IMANI, San Mateo, CA (US)

(21) Appl. No.: 13/253,858

(22) Filed: Oct. 5, 2011

(51) Int. Cl. G01N 21/95; G01N 21/88

(52) U.S. Cl. 356/72; 356/237.2

(57) ABSTRACT

A system and method for crack detection in an object using a first and a second beam of light. According to the method, a surface of the object is scanned by directing onto the object a first and a second beam of light. The first beam of light forms a localized grating pattern on the scanned surface and the second beam of light probes the scanned surface where the localized grating pattern is formed. A reflected probing beam is received. The reflected probing beam comprises a reflection of the second beam of light from the scanned surface where the localized grating pattern is formed. The reflected probing beam is analyzed to detect a signature of a crack in the object.

### TECHNICAL FIELD

The disclosed embodiments relate generally to the field of nondestructive testing and, more particularly, to a method and system for crack detection.

### BACKGROUND

A variety of crack detection systems may be used to monitor defects including cracks on metallic and other surfaces. X-ray radiography, for example, may be used to capture images of cracks on a surface of an object. X-radiography may be performed by using film as a medium to record the image or may be performed real time using various imaging screens. Other non-destructive probes such as ultrasonic waves can be used to detect cracks that may not be visible.

Use of conventional X-ray and ultrasonic crack detection system requires that the cracked object be readily accessible and may not work for situations that do not lend themselves to such restriction. For example, detecting cracks in gas, oil, or water lines, that are buried under ground and are in use, may not be practical with existing crack detection devices or systems.

Therefore, a need exists for a technique and a system that can reliably and accurately perform crack detection in environments where conventional techniques and system may not be able to operate.

### BRIEF DESCRIPTION OF THE DRAWINGS

FIG. 1A is a diagram illustrating formation of a first beam of light used in a crack detection system, according to some embodiments;

FIG. 1B is a diagram illustrating planes of the first and second beam of light used in a crack detection system, according to some embodiments;

FIG. 2A is a diagram illustrating a system for crack detection, according to some embodiments;

FIG. 2B is a diagram illustrating a signature of a crack as detected by the crack detection system of FIG. 2A, according to some embodiments;

FIG. 3 is a schematic diagram illustrating a robotic apparatus for crack detection in a tube, according to some embodiments;

FIG. 4 is a diagram illustrating a coherence length shift of a coherent probing beam of light as reflected from a crack, according to some embodiments;

FIG. 5 is a diagram illustrating a portion of the robotic apparatus of FIG. 3 equipped with an ultrasonic unit and associated waveforms, according to some embodiments; and

FIG. 6 is a flowchart of a method for crack detection in an object.

### SUMMARY

Embodiments of a system and a method for crack detection in an object using a first and a second beam of light are disclosed. According to the method, a surface of the object is scanned by directing, onto the object, a first and a second beam of light. The first beam of light forms a localized grating pattern on the scanned surface, and the second beam of light probes the scanned surface where the localized grating pattern is formed. A reflected probing beam is received. The reflected probing beam comprises a reflection of the second beam of light from the scanned surface where the localized grating pattern is formed. The reflected probing beam is analyzed to detect a signature of a crack in the object.

### Description of Embodiments

The description that follows includes exemplary systems, apparatuses, methods, and techniques that embody techniques of the present inventive subject matter. However, it is understood that the described embodiments may be practiced without these specific details.

According to an embodiment, a method for crack detection in an object comprises scanning a surface of the object by directing, onto the object, a first and a second beam of light. The first beam of light may form a localized grating pattern on the scanned surface, and the second beam of light may probe the scanned surface where the localized grating pattern is formed. A reflected probing beam is received that may comprise a reflection of the second beam of light from the scanned surface where the localized grating pattern is formed. The reflected probing beam may be analyzed to detect a signature of a crack in the object.

In one embodiment, a system for crack detection in an object comprises the following: a scanner configured to scan a surface of the object by directing onto the object a first and a second beam of light. The first beam of light may be arranged to form a localized grating pattern on the scanned surface, and the second beam of light may be arranged to probe the scanned surface where the localized grating pattern is formed. A light detector may receive a reflected probing beam that comprises a reflection of the second beam of light from the scanned surface where the localized grating pattern is formed. An analyzer may analyze the reflected probing beam to detect a signature of a crack in the object.

In some embodiments, the present disclosure may cover a method and system for inspection of gas and fluid pipe lines. The current methods may rely, for example, on infrared camera and automatic and/or manual inspection. The technique may involve robotics, automation, and a number of concurrent crude and/or fine inspections. In one aspect an army of robots may inspect aging gas pipelines. The leaks in gas pipelines may have disastrous and fatal consequences, especially in residential or commercial neighborhoods. The disclosed technique may automatically perform the inspections in an accurate, reliable, and time saving manner.

The object may comprise a tube including one of a gas line or liquid line (e.g., oil line, or a water line, and the like). The scanning may comprise a helical scan of the inside surface of the tube that may be performed by one or more robots. In some embodiments, the scanning by the first and the second beam of light may be performed concurrently. The first and the second beam of light may be arranged such that a plane of the second beam of light can be orthogonal to a plane of the first beam of light. The first beam of light may cause formation of electron density waves in a surface area where a localized grating pattern is formed. The reflected probing beam may be affected by the formation of the electron density waves, and the formation of the electron density waves may be affected by existence of a crack in the scanned surface.

In some embodiments, analysis of the reflected probing beam may comprise monitoring the reflected probing beam as an angle of incidence of the second beam of light is varied and recording an intensity of the probing beam as a function of an angle of incidence of the second beam of light with respect to the scanned surface. The second beam of light may comprise a coherent laser light beam, and the analysis of the reflected probing beam may include measuring a shift in a coherence length of the reflected probing beam with respect to the coherent laser light beam.

According to some embodiments, a coherent beam of light may be directed onto the scanned surface. A light detector may receive a reflected coherent beam that comprises a reflection of the coherent beam of light from the scanned surface where the localized grating pattern is formed. An analyzer may analyze the reflected coherent beam to measure a shift in a coherence length of the reflected coherent beam with respect to the coherent laser light beam as a signature of a crack in the object. In some embodiments, an ultrasonic beam may be directed at the scanned surface where the localized grating pattern is formed to probe the scanned surface, and the reflection of the ultrasonic beam may be analyzed to detect an additional signature of the crack in the object.

In principle, inspection may involve inducing an artificial local grating using interference patterns formed by a first beam of light (e.g., one or more excitation lasers). The gratings may be thermal in nature and be created by local heating due to build up of surface acoustic waves (SAW) with a small amplitude over the area of the excitation beam spot size on the metallic film surface. Meanwhile, due to the conservation of momentum, an electron charge may also be created on the surface of the pipe. This phenomenon is also referred to surface Plasmons formation. The electron charges may be proportional to oxidation layer on the metal and the existence of cracks or their lack of on the surface. So the excitation laser plus the induced grating may act as modulating signals for discovering the leaks and the cracks the lack thereof. The metallic surface may be subjected to several probing beams. One of the advantages of the grating formed by the surface Plasmon is that these gratings are not permanent, therefore, they preserve the non-destructive nature of the technique.

A focused ultrasound beam, as well as probing laser beams, may be applied to the spot size. One probing beam may vary with angle, so that the reflectance profile of the surface as a function of incident laser beam angle can he measured. Another laser beam, with known and fixed coherence length, may be applied to the same spot as well. The shift in coherence length of the reflected beam can identify the cracks or the lack thereof. The probing beams may be delivered via a wave guide or fiber optic cable to the sample point. The grating patterns may be larger than the spot sizes of the probing beams for obvious reasons. It may also be possible to combine the two light beams into a single light beam at the expense of compromising the accuracy of measurement.

In summary, several concurrent and simultaneous methods of measurement for crude and fine inspection of the cracks are disclosed. The probing beam may comprise an ultrasonic beam, and a second and a third beam may be light waves. One beam of light may be used for detection of surface Plasmons effect and the other one may serve as coherence length shift detection. The surface Plasmons effect may vary as a function of incident angle that can reveal a signature for the crack that can also produce a coherence length shift in the fixed coherent light source.

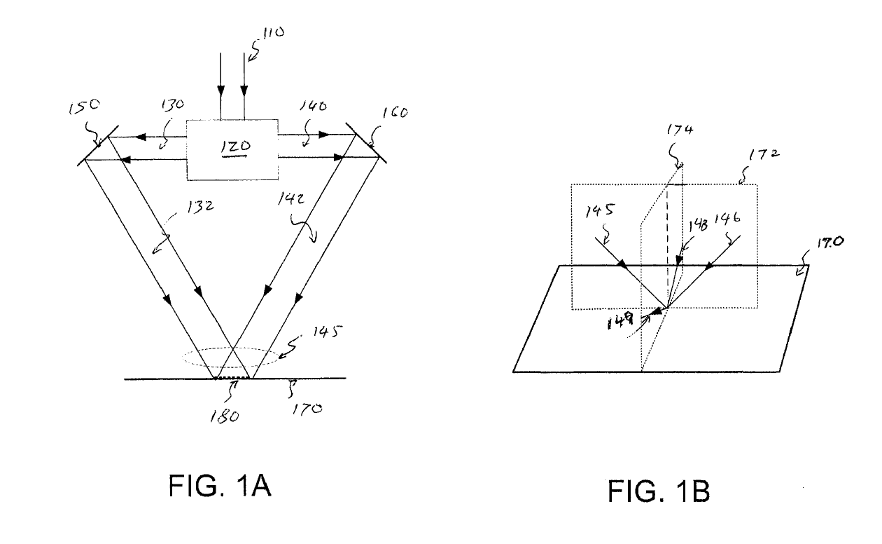

FIG. 1A is a diagram illustrating formation of a first beam of light 145 used in a crack detection system, according to some embodiments. First beam of light 145 may be formed by an interference of two separate beams of light 132 and 142. Beams 132 and 142 may be laser lights generated by two separate identical sources. The interference of light beams 132 and 142 may create surface acoustic waves that can propagate on the surface and generate temporary gratings. In some embodiments, as shown in FIG. 1, beams 132 and 142 may be produced from once source (e.g., beam 110, such as a pulsed laser beam), for example, by using an optical beam splitter 120. The splitted beams 140 and 130 may then be combined by reflecting form mirrors 160 and 150, respectively. The first beam 145 may form interference patterns that can create gratings 180 on a surface 170 of an object (e.g., inside surface of a tube, such as a gas or liquid line).

FIG. 1B is a diagram illustrating planes 172 and 174 of the first and second beam 145 and 147 of light, respectively, used in a crack detection system, according to some embodiments. Planes 172 and 174 respectively corresponding to first and second beams 45 and 146 of light may be orthogonal. Plane 172 is formed by incident first beam of light 145 and the corresponding reflected beam of light 146. Plane 174 is formed by second incident beam of light 148 and the corresponding reflected beam of light 149. First beam of light 145 may be an excitation laser (e.g., with a wavelength of 850nm) that can create surface Plasmons on the surface 170 of an object. Second beam of light 148 may be a probing beam (e.g., with a wavelength of 550nm) used to analyze the gratings to detect, for example, crack signatures.

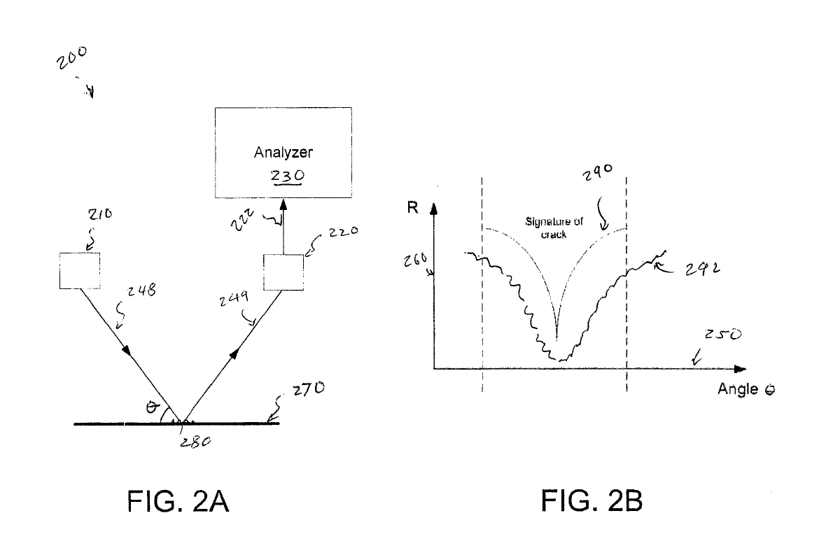

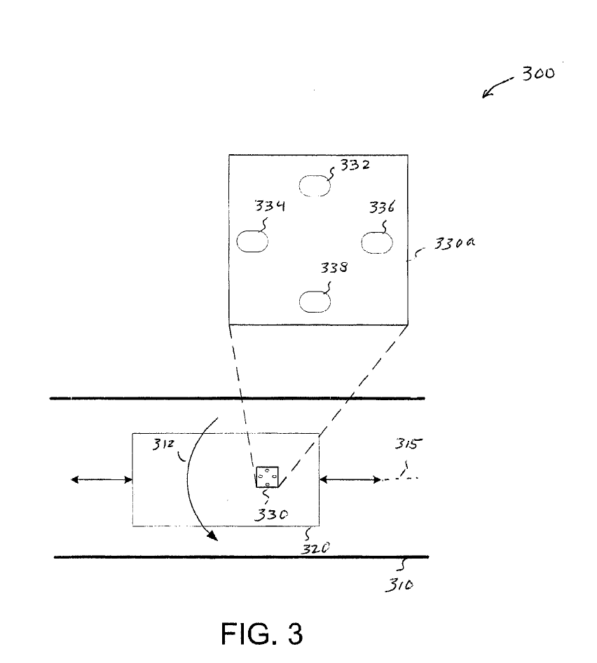

FIG. 2A is a diagram illustrating a system 200 for crack detection, according to some embodiments. System 200 may include a light source 210, a light detector 220, and an analyzer 230. Light source 210 may include a laser light source that generates a probing beam 210 to probe a grating 280 on a surface 270 of an object, such as an inside surface of a gas or liquid tube. The grating may be formed by an excitation laser beam as discussed above. A reflected probing beam 249 formed by the reflection of probe beam 248 from the grating 280 may be detected by the light detector 220 (e.g., a photodiode). Light detector 220 may generate an electrical signal 222 that can be analyzed by analyzer 230. Analyzer 230 may be a stand alone device or part of a computer (e.g., a desktop, a laptop, or a dedicated computer) the computer may include one or more processors, memory, and computer-readable storage media (e.g., magnetic or optical storage media such as a hard-drive or an optical disk). The analyzer may also be embedded in a robotic apparatus (e.g., apparatus 320 in FIG. 3). The analysis result may indicate a crack signature shown in FIG. 2B, described below.

FIG. 2B is a diagram illustrating a signature 292 of a crack as detected by the crack detection system 200 of FIG. 2A, according to some embodiments. Analyzer 230 of FIG. 2A can identify a crack signature 290 by analyzing signal 222 received from light detector 220 of FIG. 2A. As the angle θ (e.g., angle shown on axis 250 in FIG. 2B) of incidence of the probing beam 248 of FIG. 2A is varied, the intensity (e.g., R shown on axis 260 of FIG. 2B) of reflected probing beam 249 may vary depending, for example, on the condition of the surface 270 of FIG. 2. For instance, if surface 270 has any cracks or other abnormalities such as corrosion, the analyzer may be able to identify that by analyzing the signal 222 received from light detector 220. The crack signature 292 is clearly identifiable from a normal signal 290 received from a surface with no crack or other detectable abnormalities.

FIG. 3 is a schematic diagram illustrating a robotic apparatus 320 for crack detection in a tube 310, according to some embodiments. Robotic apparatus 320 includes an assembly 330 including light sources 332 and 334 and light detectors 336 and 338 as shown in the blown up assembly 330a. Light sources 332 and 334 may produce first and second light beams 145 and 148 of FIG. 1B, namely forming the exciting and probing beams, respectively. Robotic apparatus 320 may also include ultrasonic generators to generate one or more ultrasonic beams to be directed at the surface, for example at grating 280 of FIG. 2A. Robotic apparatus 320 may also include ultrasonic beam detectors to detect reflected ultrasonic beams. In some embodiments, the ultrasonic generator and detector may be positioned in a single location on the robotic apparatus 320 (see 510 in FIG. 5). Apparatus 320 may also include analyzer 230 of FIG. 2A and uses analyzer 230 to analyze detected signals (e.g., signal 222 of FIG. 2A). In some embodiments, apparatus 320 may be equipped with communication devices such as wireless communication devices to communicate reports to a central monitoring system.

Robotic apparatus 320 may also be equipped with one or more propelling means that can cause robotic apparatus 320 to move back and forth along a tube 310 (i.e., translational movement). The robotic apparatus 320 may also perform a rotational movement around a longitudinal axis 315 of tube 310 (i.e., rotational movement), as shown by rotational arrow 312. The concurrent rotational and translational movement of robotic apparatus 320 can enable helical scanning of the inside surface of tube 310 by exciting and probing beams as well as by the ultrasonic beam. In some embodiments, the probing beam can be a coherent light beam. In other embodiments, the coherent light source may be a separate light source such as a coherent laser source.

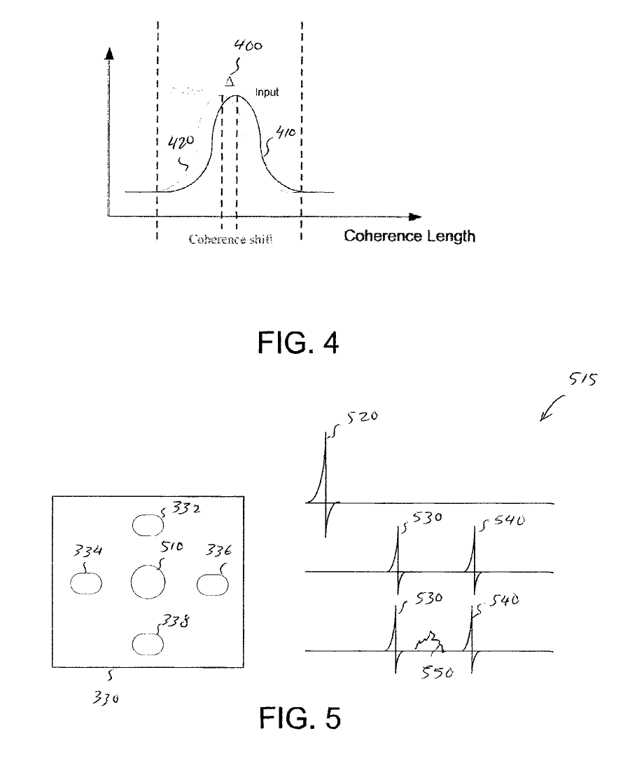

FIG. 4 is a diagram illustrating a coherence length shift 400 of a coherent probing beam of light as reflected from a crack, according to some embodiments. As mentioned above, the coherent probing beam can be the same as the probing beam 248 of FIG. 2A. Alternatively, the coherent beam may be a separate coherent laser beam. A coherent light source has a measurable coherence length. One way to identify a surface abnormality, such as a crack, is to measure the coherence length of the beam of coherent light before and after reflection from the surface. For example, curves 410 and 420 correspond to a coherent beam and a reflected coherent beam, respectively. Coherence length shift 400 shown in FIG. 4 may be an indication of an abnormality such as a crack or other defects on a scanned surface, for example, an inside surfaced of tube 310 of FIG. 3 scanned by robotic apparatus 320 of FIG. 3.

FIG. 5 is a diagram illustrating a portion 330 of the robotic apparatus 320 of FIG. 3 equipped with an ultrasonic unit 510 and associated waveforms 515, according to some embodiments. Robotic apparatus 320 of FIG. 3 may include an ultrasonic unit 510. Ultrasonic unit 510 may include an ultrasonic generator to generate an ultrasonic beam having a waveform 520 to probe a surface such as a tube inside surface, for example, at a position where an exciting light beam (e.g., a first light beam) has created gratings (e.g., spot 280 in FIG. 2A).

Upon encountering the surface, the ultrasonic beam may be reflected both from an inside and outside surfaces of the tube, thereby generating reflected waves 530 and 540. The time difference between reflected waves 530 and 540 may be an indication of a thickness (i.e., a distance between the inside and outside surfaces) of the tube. In some embodiments, if the surface includes abnormalities, such as one or more cracks, a separate reflection such as a reflected wave represented by a waveform 550 may also be detected. The position of the waveform 550 may vary between the position of the waveforms 530 and 540. Waveform 550 may form a strong signature of the crack that may be utilized separately or in combination with the probing-exciting light beams discussed with respect to FIGS. 2A and 2B.

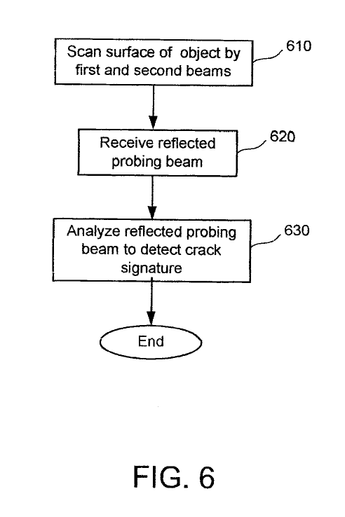

FIG. 6 is a flowchart of a method 600 for crack detection in an object. Method 600 comprise a technique for detecting cracks in an object, such as a surface, for example an inside surface of a tube 310 of FIG. 3. Method 600 may include scanning the surface of the object by directing onto the object first and second beams of light (e.g., exciting beam 145 and probing beam 148 both of FIG. 1B) (610). The first beam of light may form a localized grating pattern on the scanned surface (e.g., grating formed on spot 180 of FIG. 1A) and the second beam of light may probe the scanned surface where the localized grating pattern is formed. A reflected probing beam (e.g., reflected probing beam 249 of FIG. 2A) is received that may comprise a reflection of the second beam of light (e.g., probing beam 248 of FIG. 2A) from the scanned surface where the localized grating pattern is formed (e.g., spot 180 of FIG. 1A) (620). The reflected probing beam may be analyzed by analyzer 230 of FIG. 2A to detect a signature of a crack in the object (e.g., signature 292 of FIG. 2B) (610).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A method for crack detection in an object, the method comprising:
scanning a surface of the object by directing onto the object a first and a second beam of light, the first beam of light forming a localized grating pattern on the scanned surface and the second beam of light probing the scanned surface where the localized grating pattern is formed;
receiving a reflected probing beam that comprises a reflection of the second beam of light from the scanned surface where the localized grating pattern is formed; and
analyzing the reflected probing beam to detect a signature of a crack in the object.

2. The method of claim 1, wherein the object comprises a tube including at least one of a gas line, oil line, or a water line, and wherein the scanning comprises a helical scan of the inside surface of the tube.

3. The method of claim 1, wherein the helical scan is performed by a robot.

4. The method of claim 1, wherein the scanning by the first and the second beam of light is performed concurrently.

5. The method of claim 1, further comprising arranging a plane of the second beam of light to be orthogonal to a plane of the first beam of light.

6. The method of claim 1, wherein the first beam of light causes formation of electron density waves in a surface area where localized grating pattern is formed;

7. The method of claim 6, wherein the reflected probing beam is affected by the formation of the electron density waves, and wherein the formation of the electron density waves is affected by existence of a crack in the scanned surface.

8. The method of claim 7, wherein the analyzing of the reflected probing beam comprises monitoring the reflected probing beam as an angle of incidence of the second beam of light is varied and recording an intensity of the probing beam as a function of an angle of incidence of the second beam of light with respect to the scanned surface.

9. The method of claim 1, wherein the second light beam comprises a coherent laser light beam, and the analyzing of the reflected probing beam comprises measuring a shift in a coherence length of the reflected probing beam with respect to the coherent laser light beam.

10. The method of claim 1, further comprising:
directing onto scanned surface a coherent beam of light;
receiving a reflected coherent beam that comprises a reflection of the coherent beam of light from the scanned surface where the localized grating pattern is formed; and
analyzing the reflected coherent beam to measure a shift in a coherence length of the reflected coherent beam with respect to the coherent laser light beam as a signature of a crack in the object.

11. The method of claim 1, further comprising directing an ultrasonic beam at the scanned surface where the localized grating pattern is formed to probe the scanned surface and analyzing a reflection of the ultrasonic beam to detect an additional signature of the crack in the object.

12. A system for crack detection in an object, the system comprising:
a scanner configured to scan a surface of the object by directing onto the object a first and a second beam of light, the first beam of light arranged to form a localized grating pattern on the scanned surface and the second beam of light arranged to probe the scanned surface where the localized grating pattern is formed;
a light detector to receive a reflected probing beam that comprises a reflection of the second beam of light from the scanned surface where the localized grating pattern is formed; and
an analyzer to analyze the reflected probing beam to detect a signature of a crack in the object.

13. The system of claim 12, wherein the object comprise a tube, and wherein the scanner is integrated with a robot that is configured to move along the tube such that to perform a helical scan of the inside surface of the tube.

14. The system of claim 12, wherein the scanner is configured to perform the scanning by the first and the second beam of light concurrently.

15. The system of claim 12, wherein the scanner comprises a beam splitter and a phase inverter configured to convert a generated beam of light into two beams of lights with opposing phase angles, and wherein the two beams of light are combined to form the first beam of light.

16. The system of claim 15, wherein an interference of the two beams of lights with opposing phase angles enables the first beam of light to cause formation of electron density waves in a surface area where localized grating pattern is formed.

17. The system of claim 16, wherein the analyzer is configured to identify a signature formed by an effect on the electron density waves of an existing crack in the scanned surface.

18. The system of claim 12, wherein the analyzer is configured to analyze the reflected probing beam by monitoring the reflected probing beam as an angle of incidence of the second beam of light is varied and to record an intensity of the probing beam as a function of an angle of incidence of the second beam of light with respect to the scanned surface.

19. The system of claim 12, The system of claim 10, wherein the scanner is configured to direct the first and the second beam of light such that a plane of the second beam of light be orthogonal to a plane of the first beam of light.

20. The system of claim 12, wherein the second light beam comprises a coherent laser light beam, and wherein the scanner is further configured to measure a shift in the coherence length of the reflected probing beam.

21. The system of claim 12, wherein the scanner is further configured to direct onto scanned surface a coherent beam of light and further comprising a second light detector configured to receive a reflected coherent beam that comprises a reflection of the coherent beam of light from the scanned surface where the localized grating pattern is formed, and wherein the analyzer is further configured to analyze the reflected coherent beam to measure a shift in a coherence length of the reflected coherent beam with respect to the coherent laser light beam as a signature of a crack in the object.

22. The system of claim 12, wherein the scanner further comprises an ultrasonic beam generator configured to direct the ultrasonic beam at the scanned surface where the localized grating pattern is formed and to probe the scanned surface, and wherein the analyzer is further configured to analyze a reflection of the ultrasonic beam to detect an additional signature of the crack in the object.
